(19) United States
(12) Patent Application Publication
(10) Pub. No.: US 2014/0040323 A1
(43) Pub. Date: Feb. 6, 2014

(54) ANALYZER CONTROLLING APPARATUS

(71) Applicant: SHIMADZU CORPORATION, KYOTO-SHI (JP)

(72) Inventors: Takashi NAKAO, Kyoto-shi (JP); Toshinobu YANAGISAWA, Kyoto-shi (JP); Satoru WATANABE, Kyoto-shi (JP)

(73) Assignee: SHIMADZU CORPORATION, KYOTO-SHI (JP)

(21) Appl. No.: 13/951,985

(22) Filed: Jul. 26, 2013

(30) Foreign Application Priority Data
Jul. 31, 2012 (JP) 2012-169177

(51) Int. Cl. G06F 17/30

(52) U.S. Cl. CPC G06F 17/30247
USPC 707/812

(57) ABSTRACT

An analyzer controlling apparatus enabling a user to correctly and easily select a method file in which analysis conditions for operating an analyzer are described. An analyzer controlling apparatus reads out a method file stored in a memory and sets an analysis condition for an analyzer. The analyzer controlling apparatus includes: image creating unit for creating an image according to a predetermined rule based on content of an analysis condition described in a method file and/or a file name of the method file and for storing the image into the memory in association with the method file; an image showing unit for reading an image out of the memory and showing the image onto a display screen; and an analysis condition setting unit for reading, out of the memory, a method file associated with an image selected by a user and for setting an analysis condition for the analyzer.

### TECHNICAL FIELD

The present invention relates to an analyzer controlling apparatus that controls analyzers such as a gas chromatograph and a liquid chromatograph.

### BACKGROUND ART

In chromatography, a sample is supplied to a column using a carrier gas or a liquid mobile phase (hereinafter, these are collectively referred to as “mobile phase”), components in the sample are temporally separated in the column, and the components flowing out of the column are sequentially detected by an appropriate detector, whereby a chromatogram is created. Then, the retention time and peak area of each component are analyzed from each peak on the chromatogram, whereby the component is identified and quantified. The chromatography includes gas chromatography (GC) and liquid chromatography (LC), and is applied to wide fields such as analyses of food, medicine, and environmental substances.

An apparatus used for such chromatography is referred to as chromatograph, and includes a plurality of apparatus units such as: a mobile phase supplier for supplying a mobile phase; a sample injecting unit for injecting a prescribed amount of sample into the mobile phase; a column separating components in the sample; and a column oven keeping the column at a constant temperature.

At the time of analyzing a sample, analysis conditions are set by inputting parameters for setting items concerning each apparatus unit. Examples of the setting items include the kind of column, the sample injection amount, the column oven temperature, the kind of mobile phase, and the flow rate (linear speed) of the mobile phase. However, it requires time and effort for a user to set analysis conditions each time a sample is analyzed. To deal with this, a file (method file) in which analysis conditions that have once been set are described is stored in a memory. Then, at the time of performing an analysis, a controlling apparatus reads out the method file, and sets analysis conditions for an analyzer according to the method file (for example, Patent Document 1). With this configuration, at the time of performing an analysis again under the same analysis conditions, it is sufficient to read out the corresponding method file and instruct the controlling apparatus to execute the method file. Further, even at the time of performing an analysis again under only slightly different analysis conditions, it is sufficient to modify a small part of the read method file and then instruct the controlling apparatus to execute the modified method file.

In the case where a plurality of method files are stored in the memory, file names different for each file need to be used. In general, a method file is assigned a file name using characters (including numerals) representing part of the analysis conditions (normally, parameters for main setting items). In the case of a gas chromatograph, for example, setting items of the sample name, the kind of column, the sample injection amount, the column oven temperature, the kind of carrier gas, and the flow rate (linear speed) of the carrier gas are set at parameters of, respectively, sample A, column a (inner diameter 0.1 mm, length 10 m), sample injection amount of 3.0 μl, temperature of 100° C., H₂ gas, and flow rate of 50 sccm, and a file name using characters derived from these parameters is given.

### BACKGROUND ART DOCUMENT

### Patent Document

[Patent Document 1] JP-A 2006-201064

### DISCLOSURE OF THE INVENTION

### Problem to be Solved by the Invention

In a chromatography, the optimum analysis conditions that can provide an analysis result with high accuracy depend on a sample, a mobile phase, and other factors. Further, the accuracy of an obtained analysis result may be significantly different by just slightly changing a parameter value for one setting item or just changing the combination of parameters for a plurality of setting items. Accordingly, the optimum analysis conditions are searched for by repeating following procedures. First, analysis conditions are set with only a parameter for one of a plurality of setting items being changed, and a measurement is performed, whereby the parameter for this setting item is optimized. Subsequently, with only a parameter for another one of the plurality of setting items being changed, another measurement is performed, whereby the parameter for this setting item is optimized.

In the case of a gas chromatograph, at the time of analyzing a sample, analysis conditions are set by inputting respective standard parameters for the kind of column, the sample injection amount, the column oven temperature, the kind of carrier gas, and the flow rate of the carrier gas, and the analysis conditions are stored as a method file. A file name using characters representing the inputted parameters is given to the method file. Then, a chromatogram obtained by measurement performed under the analysis conditions thus set is checked, and a setting item whose parameter should be changed for more appropriate analysis is determined.

For example, in the case where peaks are hardly separated at a retention time on a chromatogram, the stationary phase is changed to one having a polarity with higher compatibility considering the compatibility of the column polarity with the component corresponding to the retention time. After such a stationary phase having a polarity with high compatibility is determined, the inner diameter and the length of the column are changed accordingly, whereby the optimum column is determined. Further, in order to obtain a sufficient peak height and an adequate peak shape on the chromatogram, the optimum sample injection amount is determined after changing the sample injection amount. Moreover, the column oven temperature is determined in consideration of the evaporation temperature of the sample. In order to speed up measurement, the carrier gas may be changed to hydrogen gas that enables measurement at a higher linear speed than nitrogen or helium gas. FIG. 1 shows an example in which: analysis conditions are set by changing parameters through the procedures as described above; and a plurality of method files are created.

If a plurality of method files are stored in this way, as shown in the right section of FIG. 1, a plurality of method files having similar file names (that is, having file names that are different only in changed parameter portions) are created and stored into a memory. FIG. 1 shows an example of the plurality of method files created for one sample. As the number of kinds of sample and the number of apparatus units for which parameters are changed increase, a larger number of method files are created.

When a desired method file should be selected from the method files having similar file names, it is necessary to check each file name precisely, which takes time. Further, even if each file name is checked with care, a different method file may be selected by mistake.

The present invention has an object to provide an analyzer controlling apparatus that enables a user to correctly and easily select a desired method file in which analysis conditions for correctly operating an analyzer are described.

### Means for Solving the Problem

The present invention, which has been made in order to solve the aforementioned problem, provides an analyzer controlling apparatus which reads out a method file stored in a memory and sets an analysis condition for an analyzer, the analyzer controlling apparatus including:

a) an image creating unit for creating an image according to a predetermined rule based on a content of an analysis condition described in a method file and/or a file name of the method file and for storing the image into the memory in association with the method file;
b) an image showing unit for reading an image out of the memory and for showing the image onto a display screen; and
c) an analysis condition setting unit for reading, out of the memory, a method file associated with an image selected by a user and for setting an analysis condition for the analyzer.

For example, in the case of a gas chromatograph, the content of the analysis condition includes parameters such as the kind of column, the sample injection amount, the column oven temperature, the kind of carrier gas, and the flow rate of the carrier gas. According to the predetermined rule, for example, the parameters and a related apparatus unit may be expressed using figures and symbols in the image, or the image may be colored. Specifically, for example, a capillary column and a packed column may be expressed using different figures or symbols, and a column oven may be expressed using a figure or a symbol with a different color depending on a set temperature.

The image creating unit creates an image based on the contents of the analysis conditions and/or the parameters when storing a method file in which analysis conditions and/or parameters are described in the case where, for example, analysis conditions are newly set using the analyzer controlling apparatus according to the present invention. For a method file that has already been created and stored in the memory, the image creating unit may create an image similarly based on the contents of the method file, or may create an image by extracting the contents of parameters from a string of letters of the method file name.

The analysis condition includes parameters concerning pretreatment of a sample before measurement and flow passage washing (i.e. the implementation time and the implementation order of processes such as pretreatment of a sample, measurement, and flow passage washing), in addition to parameters during the measurement. Accordingly, based on the setting contents of the implementation time and the implementation order of processes concerning an analysis, the image creating unit may create an image showing the implementation time and the implementation order of these processes (e.g. a flow chart for analysis process implementation).

In the analyzer controlling apparatus according to the present invention, the image creating unit creates an image based on the content of the analysis condition described in the method file or the file name of the method file, and stores the image into the memory. Further, the image showing unit shows the image created by the image creating unit, onto the display screen. Accordingly, the user can correctly and easily select a desired method file while visually checking the image on the display screen. If the predetermined rule includes creation of such a flow chart for analysis process implementation as described above, the user can select a desired method file while visually checking the time required for an analysis and the implementation order of processes.

The image may be a moving image. In performing a pretreatment of a sample, a measurement, and a flow passage washing as described above, normally, connection of flow passages is changed in the analyzer. Accordingly, based on preset contents for changing the flow passage connection, the image creating unit may create a moving image showing how the flow passage connection changes from the start of the process to the end of the process, together with an analysis flow. With this configuration, the user can select a desired method file while visually checking how the flow passage connection changes during the whole process of the analysis.

### Effects of the Invention

In the analyzer controlling apparatus according to the present invention, the image creating unit creates an image based on the content of the analysis condition described in the method file or the file name of the method file, and stores the image into the memory. Further, the image showing unit shows the image created by the image creating unit, onto the display screen. Accordingly, the user can correctly and easily select a desired method file while visually checking the image on the display screen.

### BRIEF DESCRIPTION OF THE DRAWINGS

FIG. 1 is a table for illustrating a method of giving a file name to a method file.

FIG. 2 is a diagram for illustrating a configuration of an embodiment of an analyzer controlling apparatus according to the present invention.

FIGS. 3A and 3B are diagrams for illustrating an example of an image created by image creating unit in the analyzer controlling apparatus of the present embodiment.

FIGS. 4A and 4B are diagrams for illustrating another example of an image created by the image creating unit in the analyzer controlling apparatus of the present embodiment.

FIG. 5 is a diagram showing a selection screen of method files in the analyzer controlling apparatus of the present embodiment.

FIG. 6 is a diagram for illustrating a configuration of another embodiment of the analyzer controlling apparatus according to the present invention.

FIGS. 7A and 7B are diagrams for illustrating an embodiment in which the image creating unit creates a flow chart for analysis process implementation.

FIGS. 8A and 8B are diagrams for illustrating an embodiment in which the image creating unit creates a moving image.

### BEST MODES FOR CARRYING OUT THE INVENTION

An embodiment of an analyzer controlling apparatus according to the present invention is described. The present embodiment is an analyzer controlling apparatus for a gas chromatograph. FIG. 2 shows a configuration of a main part of each of a gas chromatograph 1 that is a control target apparatus and an analyzer controlling apparatus 10 of the present embodiment. Apparatus units constituting the gas chromatograph 1 each operate when receiving a predetermined signal from the analyzer controlling apparatus 10 to be described later through an apparatus unit controller 8.

In the gas chromatograph 1, an amount of liquid sample is injected into a sample evaporation chamber 2 that is kept at a predetermined temperature by a heater, the amount being defined in analysis conditions to be described later. A carrier gas of the kind defined in the analysis conditions is introduced from a gas cylinder (not shown) into the sample evaporation chamber 2 while the speed of the carrier gas is regulated at a predetermined linear speed by a flow rate regulator (AFC) 3. The sample gas generated through evaporation in the sample evaporation chamber 2 is supplied to a capillary column 6 in a column oven 5 kept at a predetermined temperature, together with the carrier gas. Components contained in the sample gas are temporally separated while passing through the capillary column 6, flow out of the capillary column 6, and are sequentially detected by a detector 7.

The analyzer controlling apparatus 10 of the present embodiment is a computer in which applications for operating the gas chromatograph 1 are installed, and includes a memory 11, image creating unit 12, image showing unit 13, and an analysis condition setting unit 14, as its functions. Further, an input unit 20 (a keyboard and a mouse) and a display unit 30 (a display) are connected to the analyzer controlling apparatus 10.

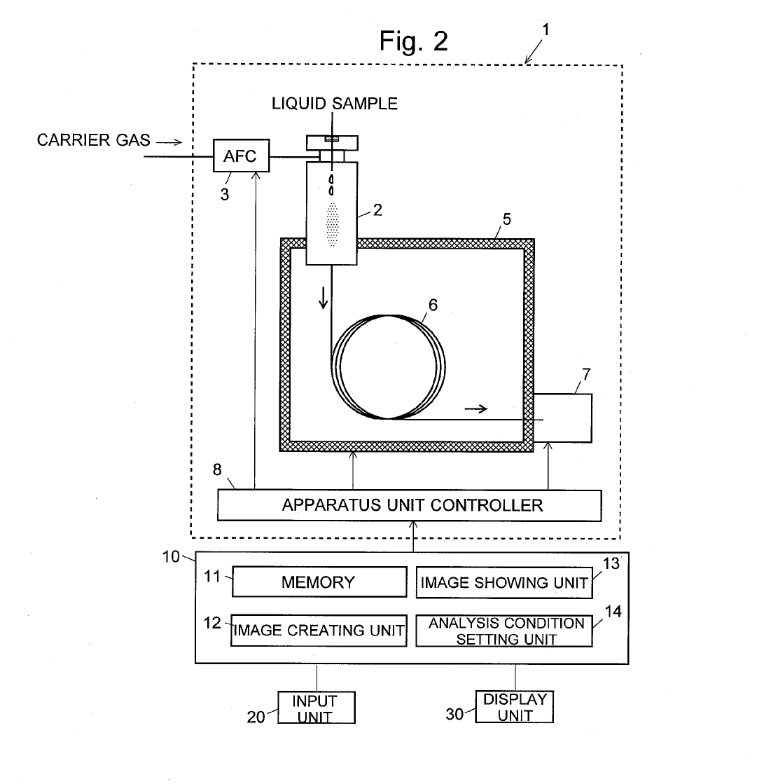

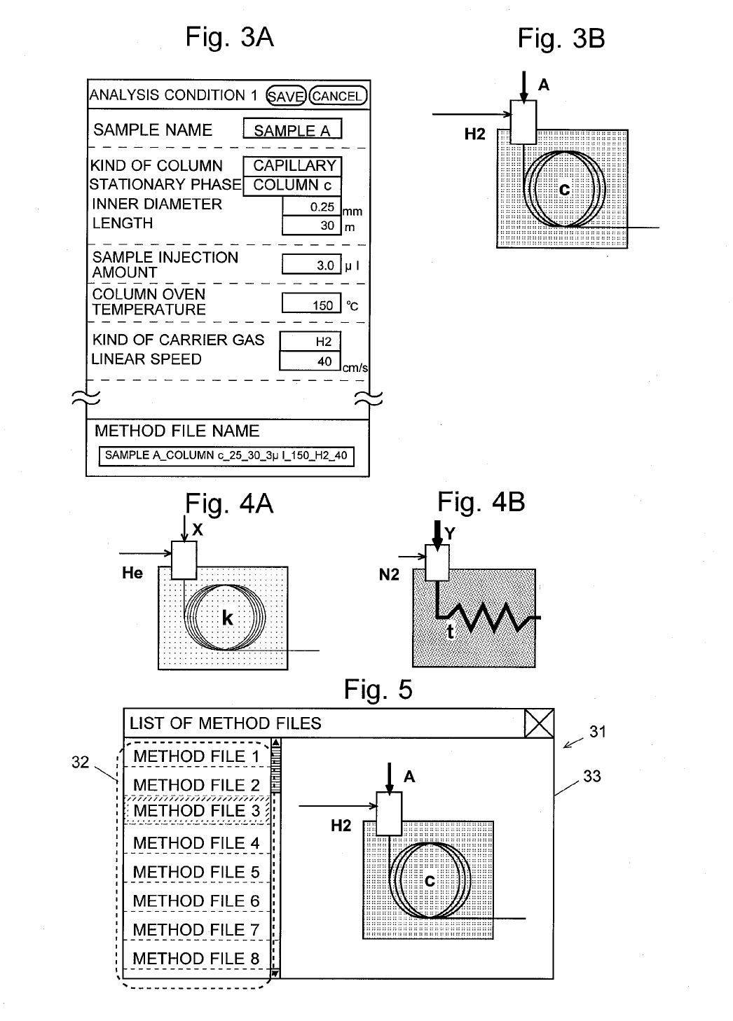

Hereinafter, an operation of the analyzer controlling apparatus 10 of the present embodiment is described. FIG. 3A shows an example of an analysis condition setting screen. Because there are a wide variety of setting items, only part of the setting items are shown in the example of FIG. 3A. If a user sets analysis conditions and stores a method file, the image creating unit 12 creates an image according to predetermined rules based on the set analysis conditions. In the present embodiment, the image creating unit 12 creates an image according to the following rules based on a schematic diagram of a configuration of a main part of the gas chromatograph, and stores the image into the memory 11 in association with the method file.

Sample: A sample name and an arrow having a thickness corresponding to the sample injection amount are expressed at a position above a sample injecting unit.

Column: A capillary column is expressed as a figure using one or more circles, and a packed column is expressed using a zigzag line. The kind of stationary phase is expressed using characters and symbols. The column inner diameter is expressed by the line thickness of the figure, and the column length is expressed by the number of the circles or the length of the zigzag line.

Column oven temperature: Expressed by coloring the column oven with a color corresponding to each temperature.

Carrier gas: The kind of carrier gas is expressed using characters or symbols, and the flow rate thereof is expressed by the length of an arrow.

The image creating unit 12 creates an image shown in FIG. 3B according to the above-mentioned rules based on the analysis conditions set as shown in FIG. 3A. Note that, in FIG. 3B, the column oven temperature is expressed by hatching the column oven instead of coloring it, in the above-mentioned rules.

FIG. 4A and FIG. 4B each show another example of an image that is created according to the above-mentioned rules based on different analysis conditions. These images are created based on the following analysis conditions.

FIG. 4A: a sample X, a column (a capillary column, a stationary phase k, an inner diameter 0.10 mm, a length 50 m), a sample injection amount of 1.0 μl, a column oven temperature of 100° C., and a carrier gas (kind He, a linear speed of 30 cm/sec)

FIG. 4B: a sample Y, a column (a packed column, a stationary phase t, an inner diameter of 3.0 mm, a length of 5.0 m), a sample injection amount of 15.0 μl, a column oven temperature of 200° C., and a carrier gas (kind N₂, a linear speed of 15 cm/sec)

At the time of storing the image file, the image creating unit 12 stores the created image into the memory 11, as an image file different from a method file. A database region is provided inside of the memory 11, and the image creating unit 12 writes a relation with the method file into the database region at the time of storing the image file. The analysis condition setting unit 14 to be described later reads out information written in the database region in the memory 11, and reads out a method file associated with an image selected by the user.

Note that, instead of the above-mentioned method for storing an image, image data may be incorporated into part of a method file, and the resultant file may be stored as one file. In this case, the database region does not need to be provided inside of the memory 11.

Next, description is given of the case where the user takes a method file that has already been created, into the analyzer controlling apparatus 10 of the present embodiment, and uses the method file. Two methods are conceivable in this case.

In the first method, the analyzer controlling apparatus 10 of the present embodiment reads thereinto a method file that has already been created, and the image creating unit 12 creates an image in such procedures as described above, and stores the image into the memory 11 in association with the method file.

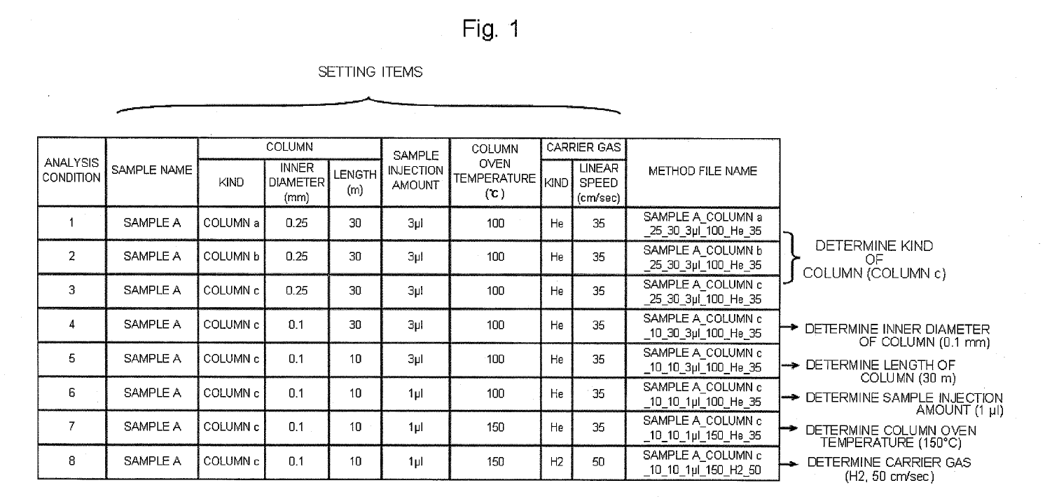

In the second method, the image creating unit 12 extracts parameters for setting items used for image creation, from the file name of a method file, and creates an image. The user needs to give in advance a file name following a predetermined rule to the method file, in order to enable the image creating unit 12 to extract the parameters for the setting items used for image creation, from the file name. The file name following a predetermined rule refers to, for example, file names in the forms as shown in the right section of FIG. 1 and the lower section of FIG. 3A, in which parameters for setting items are written in predetermined order with a symbol “_” being interposed between adjacent parameters. The image creating unit 12 creates an image based on the parameters for the setting items written in the file name, and stores the image into the memory 11 in association with the method file.

Next, description is given of an operation of the analyzer controlling apparatus 10 of the present embodiment when the user selects a desired method file. FIG. 5 shows a method file selection screen 31 in the analyzer controlling apparatus 10 of the present embodiment. If the user opens the method file selection screen 31, the image showing unit 13 shows the file names of method files stored in the memory 11, in a left portion (file name display region 32) of the method file selection screen 31 on the display 30. Note that a file name obtained by representing parameters for main setting items using characters is generally given to each method file, but the file names in FIG. 5 are shown as “METHOD FILE 1” and the like, for ease of description.

The user selects a method file showed in the file name display region 32 by, for example, clicking the mouse 20, visually checks images showed in an image display region 33 one after another, and selects a desired method file. FIG. 5 shows an example case where the user selects a method file 3 from the list of files. If the user decides a method file to be used with a double-click or the like of the mouse 20, the analysis condition setting unit 14 reads the method file associated with the image selected by the user out of the memory 11, and sets parameters for setting items concerning each apparatus unit constituting the analyzer based on analysis conditions described in this method file.

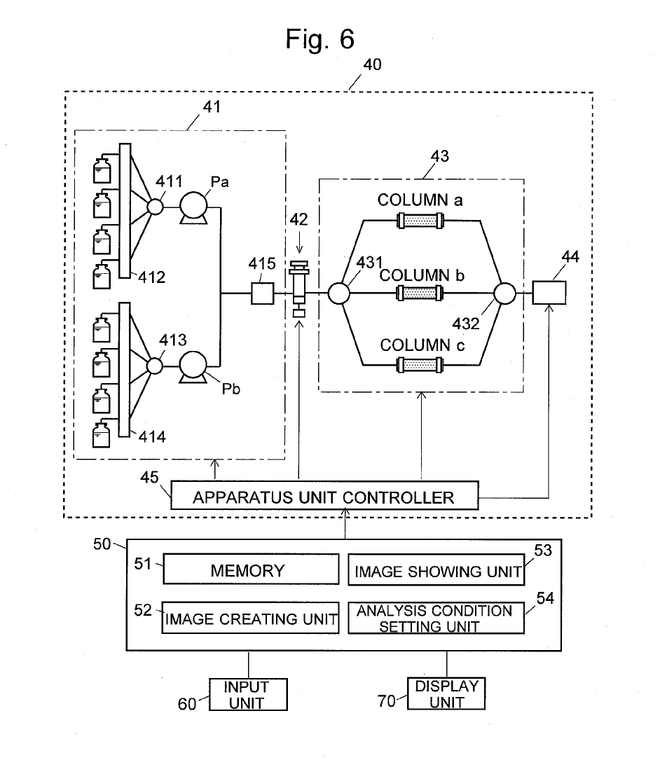

Next, description is given of another embodiment of the analyzer controlling apparatus according to the present invention. The present embodiment is an analyzer controlling apparatus for a liquid chromatograph. FIG. 6 shows a configuration of a main part of a liquid chromatograph 40 and an analyzer controlling apparatus 50 of the present embodiment.

The liquid chromatograph 40 includes a liquid supplier 41, an injector 42, a column oven 43, a detector 44, and an apparatus unit controller 45 controlling these components.

The liquid supplier 41 causes a gradient mixer 415 to mix a solvent A and a solvent B, and supplies the mixed solvent to a column A plurality of solvent containers are connected to pumps Pa and Pb through solvent selector valves 411 and 413 and degassers 412 and 414, respectively. An aqueous solvent is contained in the solvent containers connected to the pump Pa. One of the solvent containers is selected by operating the solvent selector valve 411, and the solvent in the selected container is drawn as the solvent A by the pump Pa to be supplied to the gradient mixer 415. An organic solvent is contained in the solvent containers connected to the pump Pb. One of the solvent containers is selected by operating the solvent selector valve 413, and the solvent in the selected container is drawn as the solvent B by the pump Pb to be supplied to the gradient mixer 415. The column oven 43 includes: three columns (a column a, a column b, and a column c); and passage selectors 431 and 432 for selectively connecting any one of these columns to the flow passage of a mobile phase. Components in a sample that have been temporally separated while passing through the column are detected by the detector 44.

Similarly to the above-mentioned analyzer controlling apparatus 10 for the gas chromatograph 1, the analyzer controlling apparatus 50 of the present embodiment is a computer in which applications for operating the liquid chromatograph 40 are installed, and includes a memory 51, image creating unit 52, image showing unit 53, and an analysis condition setting unit 54, as its functions. Further, an input unit 60 (a keyboard and a mouse) and a display unit 70 (a display) are connected to the analyzer controlling apparatus 50.

In the liquid chromatograph, pretreatment of a sample before measurement and flow passage washing are performed at the time of performing an analysis. Hence, analysis conditions are set by inputting parameters for setting items concerning these processes. In the present embodiment, an example of an image that is created by the image creating unit 52 in such a case is described. Note that an operation of the analyzer controlling apparatus 50 when the user selects a desired method file is the same as that of the above-mentioned analyzer controlling apparatus 10, and hence description thereof is omitted.

In the present embodiment, pretreatment is performed for 3 minutes, and measurement is then started. In the pretreatment, the mobile phase is caused to flow in the flow passage and is stabilized. Two columns (the column a and the column b) are used for the measurement, and components that are temporally separated in each column are detected. At the start of the measurement, the sample is caused to flow in the column a, and the measurement is performed for 7 minutes. Subsequently, the sample is caused to flow in the column b, and the measurement is performed for 7 minutes. At the same time as the start of the measurement, the column c, which is not used for the measurement in the present embodiment, is washed.

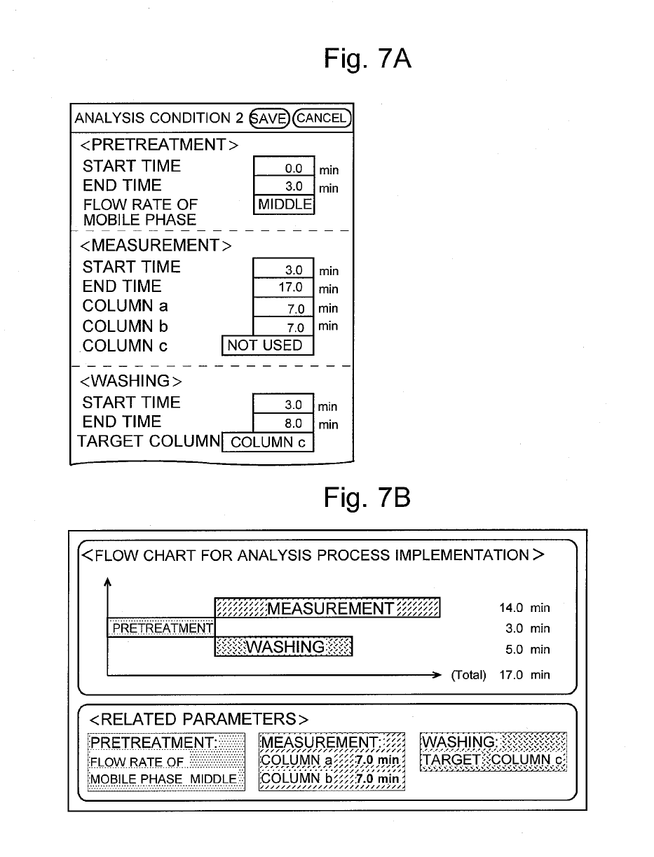

First, as shown in FIG. 7A, the user sets analysis conditions by inputting: the start time and the end time of each of pretreatment, measurement, and washing; and parameters for setting items concerning these processes, and stores the set analysis conditions as a method file. In the present embodiment, the user inputs, as the setting items: the flow rate of the mobile phase for the pretreatment; use or non-use and the duration of use of each column for the measurement; and a washing target column for the washing.

If the user sets the analysis conditions, the image creating unit 52 creates an image shown in FIG. 7B. Specifically, the image creating unit 52 creates an image which is horizontally divided into two regions. In the upper region, the image creating unit 52 shows the implementation order and time of the processes such as the pretreatment, the measurement, and the washing, in the form of a flow chart for analysis process implementation. In the lower region, the image creating unit 52 shows the parameters for the setting items concerning these processes. Each of the shown parameters is provided with the same color (or hatching) as that given to the corresponding process in the flow chart for analysis process implementation shown in the upper region.

In the case where the image creating unit 52 creates such an image as described above, the user can select a desired method file while visually checking the time required for an analysis, the implementation order of processes, and parameters for setting items concerning these processes.

In the case as in the above-mentioned example where a plurality of columns are used for measurement, flow passages are switched during the measurement. In this case, the image creating unit 52 may create a moving image in the following manner.

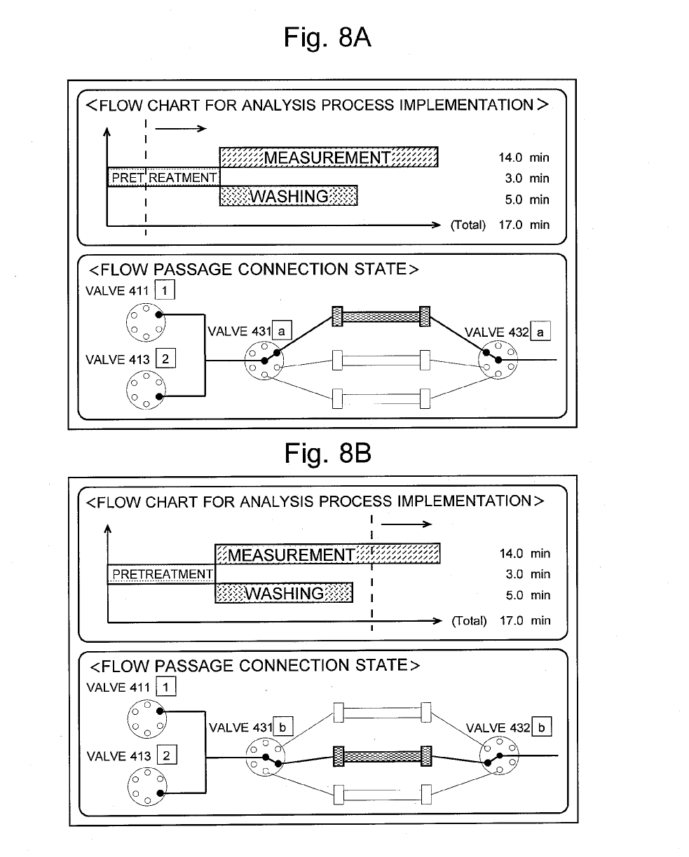

If the user sets analysis conditions by respectively inputting parameters for setting items including flow passage switching procedures (in the present embodiment, use or non-use and the duration of use of each column) in each process, the image creating unit 52 creates a moving image shown in FIG. 8. Specifically, the image creating unit 52 creates a moving image which is horizontally divided the moving image into two regions. In the upper region, the image creating unit 52 shows, with time, the implementation order and time of the processes such as the pretreatment, the measurement, and the washing, in the form of a flow chart for analysis process implementation. In the lower region, the image creating unit 52 shows a flow passage connection state so as to follow the display with time of the flow chart for analysis process implementation. In the example shown in FIG. 8, the connection state of four valves (the valves 411, 413, 431, and 432 in the liquid chromatograph shown in FIG. 6) is showed in the lower region, and a column in use and a flow passage through which the sample is currently flowing are highlighted using heavy lines and coloring. A bar (a vertical broken line in FIG. 8) for indicating with time the implemented processes is showed on the flow chart for analysis process implementation in the upper region. The flow passage connection state during implementation of each process is showed in the lower region. Because FIG. 8A corresponds to the first stage in the analysis process, the bar in the upper region is located at the pretreatment process, and the flow passage connection state during implementation of the pretreatment process is showed in the lower region. The bar in the upper region gradually moves rightward with time from the state shown in FIG. 8A to the state shown in FIG. 8B. In FIG. 8B, the bar in the upper region is located at the latter portion of the measurement process, and the flow passage connection state during implementation of the latter portion of the measurement process (during the measurement using the column b) is showed in the lower region.

In the case where the image creating unit 52 creates such a moving image as described above, the user can select a desired method file while visually checking how the flow passage connection state changes during implementation of a series of processes for analysis.

All the above-mentioned embodiments are given as mere examples, and can be changed and modified as appropriate within the spirit of the present invention. In the above-mentioned embodiments, the analyzer controlling apparatus for the gas chromatograph or the liquid chromatograph is described as an example, but the present invention can be applied to a variety of analyzers, such as a spectroanalyzer, in which analysis conditions are set by respectively inputting parameters to a plurality of setting items. In the case where the analyzer controlling apparatus is used for an analyzer other than those in the above-mentioned embodiments, the image creating unit may be configured to create an image based on parameters for characteristic setting items included in analysis conditions, in consideration of characteristics of the analyzer.

In the above-mentioned embodiments, the image creating unit creates an image of parameters for setting items included in analysis conditions, using figures, symbols, a flow chart for analysis process implementation, and the like. Alternatively, the image creating unit may create an image and show the entirety or part of the analysis condition setting screen as it is. In the case where it takes time to read out a method file, it also takes time to open a plurality of method files one by one and check analysis conditions described in each method file. In such a case, if an image of the entirety or part of the analysis condition setting screen is created, it is not necessary to read out the plurality of method files one by one, so that the time required to select a desired method file can be shortened.

### EXPLANATION OF NUMERALS

1 . . . Gas Chromatograph
2 . . . Sample Evaporation Chamber
3 . . . Flow Rate Regulator
5 . . . Column Oven
6 . . . Capillary Column
7 . . . Detector
8, 45 . . . Apparatus Unit Controller
10, 50 . . . Analyzer Controlling Apparatus
11, 51 . . . Memory
12, 52 . . . Image Creating Unit
13, 53 . . . Image Showing unit
14, 54 . . . Analysis Condition Setting unit
20 . . . Input Unit
30 . . . Display Unit
31 . . . Method File Selection Screen
32 . . . File Name Display Region
33 . . . Image Display Region
40 . . . Liquid Chromatograph
41 . . . Liquid Supplier
411, 413 . . . Solvent Selector Valve
412, 414 . . . Degasser
415 . . . Gradient Mixer
42 . . . Injector
43 . . . Column Oven
431, 432 . . . Flow Passage Selector
44 . . . Detector

1. An analyzer controlling apparatus which reads out a method file stored in a memory and sets an analysis condition for an analyzer, the analyzer controlling apparatus comprising:
a) an image creating unit for creating an image according to a predetermined rule based on a content of an analysis condition described in a method file and/or a file name of the method file and for storing the image into the memory in association with the method file;
b) an image showing unit for reading an image out of the memory and for showing the image onto a display screen; and
c) an analysis condition setting unit for reading, out of the memory, a method file associated with an image selected by a user and for setting an analysis condition for the analyzer.

2. The analyzer controlling apparatus according to claim 1, wherein
the image creating unit creates, based on setting contents of implementation time and/or implementation order of a plurality of processes concerning an analysis described in the method file, an image showing the implementation time and/or the implementation order of the plurality of processes.

3. The analyzer controlling apparatus according to claim 1, wherein
the image is a moving image.

4. The analyzer controlling apparatus according to claim 3, wherein
the moving image shows a change in apparatus configuration during an analysis.

5. The analyzer controlling apparatus according to claim 2, wherein
the image is a moving image.

6. The analyzer controlling apparatus according to claim 5, wherein
the moving image shows a change in apparatus configuration during an analysis.
